(19) United States
(12) Patent Application Publication
(10) Pub. No.: US 2014/0130167 A1
(43) Pub. Date: May 8, 2014

(54) SYSTEM AND METHOD FOR PERIODICALLY INSPECTING MALICIOUS CODE DISTRIBUTION AND LANDING SITES

(71) Applicant: KOREA INTERNET & SECURITY AGENCY, Seoul (KR)

(72) Inventors: Tai Jin LEE, Seoul (KR); Byung Ik KIM, Seoul (KR); Hong Koo KANG, Seoul (KR); Chang Yong LEE, Seoul (KR); Ji Sang KIM, Seoul (KR); Hyun Cheol JEONG, Seoul (KR)

(73) Assignee: KOREA INTERNET & SECURITY AGENCY, Seoul (KR)

(21) Appl. No.: 14/062,016

(22) Filed: Oct. 24, 2013

(30) Foreign Application Priority Data
Nov. 6, 2012 (KR) 10-2012-0125007

(51) Int. Cl. H04L 29/06

(52) U.S. Cl. CPC H04L 63/1408
USPC 726/24

(57) ABSTRACT

A system and method for periodically inspecting malicious code distribution and landing sites, which receives a malicious-suspected URL from a management server; collects a file which is created when the malicious-suspected URL is connected and self-inspecting existence of the malicious code in the collected file using a commercial vaccine; traces, if a malicious code is detected in the collected file, a final distribution site distributing the detected malicious code; confirms information on a landing site connected to the final distribution site and registering the final distribution site and the landing site in a landing/distribution site database; confirms whether or not the final distribution site and the landing site registered in the landing/distribution site database are connectible; and updates the landing/distribution site database according to whether or not the final distribution site and the landing site are connectible.

### BACKGROUND OF THE INVENTION

1. Field of the Invention

The present invention relates to a system and method for periodically inspecting malicious code distribution and landing sites, which promptly confirms existence of a malicious code by inspecting a malicious behavior itself affected on a collected file, detects the malicious code distribution and landing sites by tracing a network route, and periodically inspects whether or not the malicious code distribution and landing sites distribute the malicious code.

2. Background of the Related Art

Although a lot of people may use the Internet regardless of time and space owing to advancement in information communication technologies and distribution of portable terminals, serious social problems, such as leakage of personal information, Distributed Denial of Service (DDoS) attacks, cyber terrors, disclosure of privacy and the like, are generated through the Internet.

However, since the prior art collects a file which is created when a user visits a website and detects a malicious code existing in the collected file by consulting an external analysis system to inspect the collected file, existence of a malicious code in the collected files may not be confirmed in a speedy way.

Furthermore, since the prior art detects a malicious code distribution site or only one landing site among the landing sites, it may not correctly determine whether a URL creating a malicious code is a malicious code distribution site or a malicious code landing site although malicious code is actually collected.

### SUMMARY OF THE INVENTION

Therefore, the present invention has been made in view of the above problems, and it is an object of the present invention to provide a system and method for periodically inspecting malicious code distribution and landing sites, which promptly confirms existence of a malicious code by inspecting a malicious behavior itself affected on a collected file using a commercial vaccine.

In addition, another object of the present invention is to provide a system and method for periodically inspecting malicious code distribution and landing sites, which detects the malicious code distribution and landing sites by tracing a network route and periodically inspects whether or not the malicious code distribution and landing sites distribute the malicious code.

To accomplish the above objects, according to one aspect of the present invention, there is provided a method of periodically inspecting malicious code distribution and landing sites, the method including the steps of: receiving a malicious-suspected URL from a management server; collecting a file which is created when the malicious-suspected URL is connected and self-inspecting existence of the malicious code in the collected file using a commercial vaccine; tracing, if the malicious code is detected in the collected file, a final distribution site distributing the detected malicious code; confirming information on a landing site connected to the final distribution site and registering the final distribution site and the landing site in a landing/distribution site database; confirming whether or not the final distribution site and the landing site registered in the landing/distribution site database are connectible; and updating the landing/distribution site database according to whether or not the final distribution site and the landing site are connectible.

In addition, the self-inspection step includes the steps of: driving, by a collected file self-inspection server, the commercial vaccine according to a vaccine driving policy received from the management server and activating a real-time update function and a real-time monitoring function of the commercial vaccine; receiving, by the collected file self-inspection server, the collected file; and detecting, by the collected file self-inspection server, the malicious code from the collected file using the commercial vaccine.

In addition, if the malicious code is detected in the collected file at the malicious code detection step, a malicious code list is created.

In addition, if the malicious code is not detected in the collected file at the malicious code detection step, existence of the malicious code in the collected file is re-inspected at predetermined inspection intervals, and a white list is created using normal files in which the malicious code is not detected.

In addition, the final distribution site tracing step confirms the final distribution site distributing the collected file in which the malicious code is detected by tracing a network route.

In addition, the step of confirming whether or not the distribution site and the landing site are connectible confirms whether or not the distribution site and the landing site are connectible at predetermined intervals.

In addition, the step of confirming whether or not the distribution site and the landing site are connectible includes the step of directly visiting the connectible distribution and landing sites and detecting whether or not the malicious code is distributed.

In addition, according to another aspect of the present invention, there is provided a system for periodically inspecting malicious code distribution and landing sites, the system including: a landing and distribution site periodic inspection server for collecting a file by visiting and inspecting a malicious-suspected URL, tracing a final distribution site of a malicious code detected in the collected file, confirming information on a landing site connected to the final distribution site, registering the landing site in a landing/distribution site database together with the final distribution site, confirming whether or not the distribution site and the landing site registered in the landing/distribution site database are connectible at predetermined intervals, and updating the landing/distribution site database according to a result of the confirmation; a collected file self-inspection server for self-inspecting existence of the malicious code in the collected file using a commercial vaccine and transmitting a result of the inspection to the landing and distribution site periodic inspection server; and a management server for managing the malicious-suspected URL, the collected file, a result of inspection of the landing and distribution site periodic inspection server and the collected file self-inspection server.

In addition, the collected file self-inspection server sets a reception folder according to a file reception policy and receives the collected file into the corresponding reception folder.

In addition, the collected file self-inspection server compares a hash list of a file existing in the reception folder with a hash list created when the collected file is received and determines a file which does not exist in the hash list created when the file is received as a file including the malicious code.

### BRIEF DESCRIPTION OF THE DRAWINGS

FIG. 1 is a block diagram showing a system for periodically inspecting malicious code distribution and landing sites according to the present invention.

FIG. 2 is a view showing the internal structure of the collected file self-inspection server of FIG. 1.

FIG. 3 is a view showing the internal structure of the landing and distribution site periodic inspection server of FIG. 1.

FIG. 4 is a flowchart illustrating a method of periodically inspecting malicious code distribution and landing sites according to the present invention.

FIG. 5 is an exemplary view showing a method of tracing a malicious code final distribution site related to the present invention.

### DESCRIPTION OF REFERENCE CHARACTERS

100: System for periodically inspecting malicious code distribution and landing sites
110: Collected file self-inspection server
120: Landing and distribution site periodic inspection server
130: Collected file management terminal
140: Management server
200: Malicious code analysis system

### DETAILED DESCRIPTION OF THE PREFERRED EMBODIMENT

An embodiment according to the present invention will be hereafter described in detail with reference to the accompanying drawings.

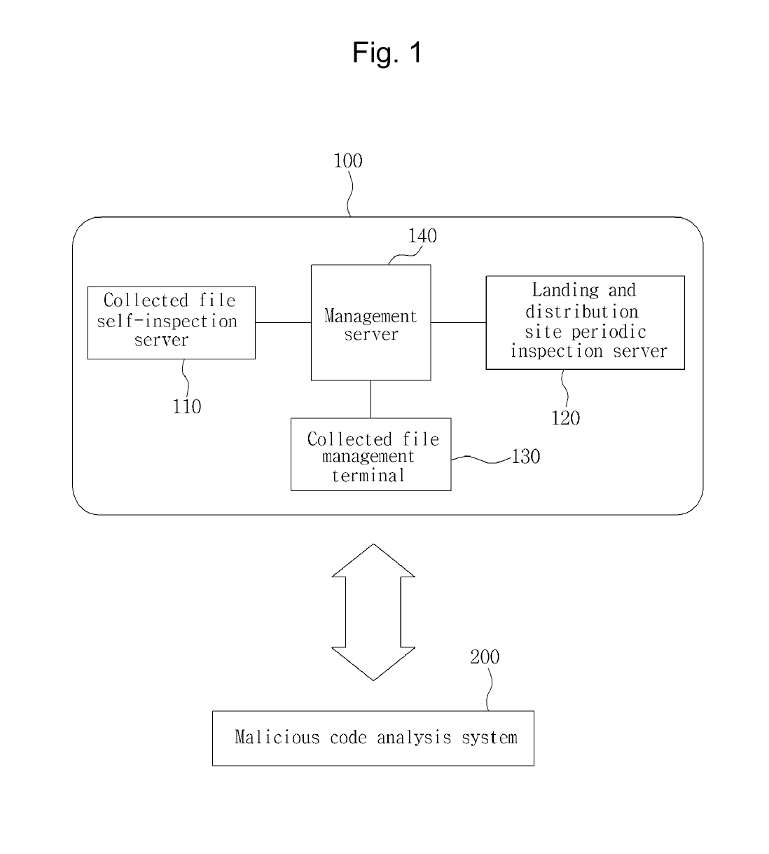

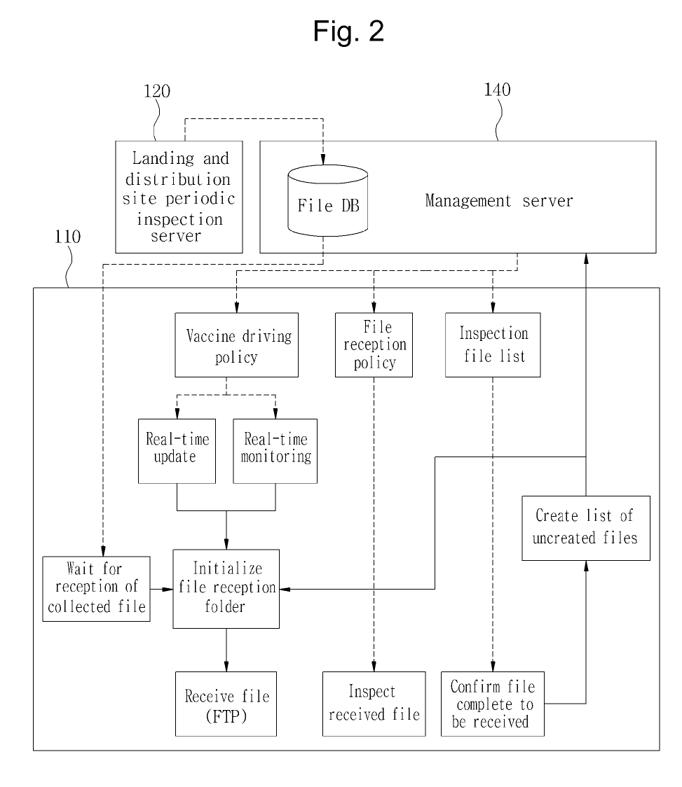

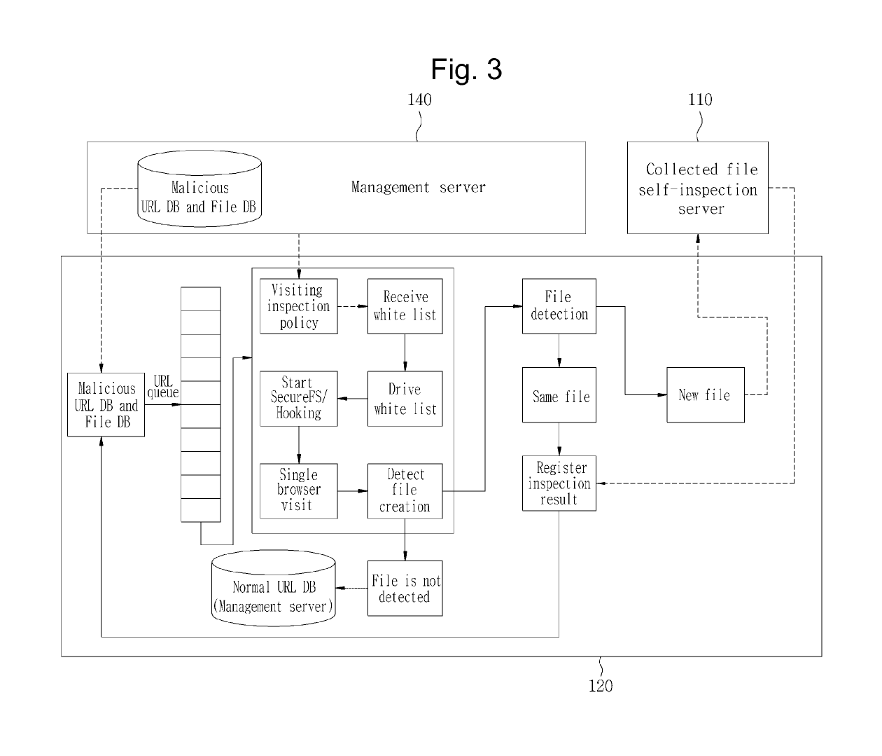

FIG. 1 is a block diagram showing a system for periodically inspecting malicious code distribution and landing sites according to the present invention, FIG. 2 is a view showing the internal structure of the collected file self-inspection server of FIG. 1, and FIG. 3 is a view showing the internal structure of the landing and distribution site periodic inspection server of FIG. 1.

Referring to FIG. 1, the system for periodically inspecting malicious code distribution and landing sites 100 includes a collected file self-inspection server 110, a landing and distribution site periodic inspection server 120, a collected file management terminal 130 and a management server 140.

The collected file self-inspection server 110 inspects whether or not a malicious code exists in a collected file by performing self-inspection on the collected file using a commercial vaccine. Here, the collected file is a file collected and managed by the management server 140 and includes a new collected file and a normal file. In addition, the commercial vaccine includes vaccines such as V3, Alyac, ViRobot, ClamWin, Avira, McAfee and the like. The collected file self-inspection server 110 allocates one virtual machine for each vaccine using a virtualization server (e.g., VMWare ESXi 4.1 or VMWare ESXi 4.0).

The collected file self-inspection server 110 performs self-inspection on the collected file at predetermined inspection intervals as shown in Table 1 in association with the commercial vaccine. Here, the inspection intervals are changed and file collection period settings are adjusted by a manager at a management website.

TABLE 1

| File collection periods | Inspection intervals | Remarks |
|---|---|---|
| At the time point of | Once | Inspect after initially |
| collection | | collecting file |
| Initial collection day | Four times a day | For one week after |
| to seven days | | initial collection |
| Eight to fifteen days | Twice a day | |
| Sixteen to thirty days | Once a day | |
| Thirty days to three | Three times a week | |
| months | | |
| Four months or more | Once a week | |

The collected file self-inspection server 110 activates a real-time monitoring function and a real-time update function of the vaccine installed in the virtual machine (GuestOS) according to a vaccine driving policy transmitted from the management server 140. Accordingly, the collected file self-inspection server 110 receives a collection file using a file transfer protocol such as File Transfer Protocol (FTP) through real-time monitoring and immediately confirms whether or not a malicious code is detected by inspecting the received collection file. Then, the collected file self-inspection server 110 deletes files in which a malicious code is detected.

In addition, the collected file self-inspection server 110 receives an inspection target file (collected file) through FTP according to a file reception policy provided by the management server 140. Here, the file reception policy includes information on FTP settings, reception folder settings, an inspection file list, and the collected file management terminal 130.

The collected file self-inspection server 110 monitors the received inspection target file in real-time and inspects existence of a malicious code. When the inspection performed on the received collection file is completed, the collected file self-inspection server 110 creates a malicious code detection list and a white list of normal files as a result of the inspection and transmits the lists to the management server 140.

The management server 140 copies normal files from which a malicious code is not detected and transmits the normal files to the collected file self-inspection server 110, and the management server 140 transmits hash information of the transmission target files when the normal files are transmitted. The hash information is a value unique to a file used as a criterion for determining a malicious code.

The collected file self-inspection server 110 sets a specific folder as a reception folder according to the file reception policy and receives collected files into the corresponding folder. Then, the collected file self-inspection server 110 monitors creation of a file (detects a malicious code) while the collected files are received into the reception folder through the FTP. Then, if transmission of the collected files is completed, the collected file self-inspection server 110 creates a hash list of the collected files existing in the reception folder. The collected file self-inspection server 110 compares the hash list of the collected files existing in the reception folder with a hash list created when the files are received and determines a file which does not exist in the hash list created when the files are received as a malicious code. The collected file self-inspection server 110 creates a malicious code hash list for the files from which a malicious code is detected and transmits the malicious code hash list to the management server 140. After transmitting the malicious code hash list to the management server 140, the collected file self-inspection server 110 deletes the files existing in the folder through initialization of the reception folder.

The landing and distribution site periodic inspection server 120 is configured of a distribution site periodic inspection module 121 and a landing site periodic inspection module 122.

The distribution site periodic inspection module 121 inspects whether or not a malicious code final distribution site detected until present is connectible and inspects whether or not the malicious code is distributed from the malicious code final distribution site determined as connectible as a result of the inspection. In addition, if a file is not created at the final distribution site, the distribution site periodic inspection module 121 determines the corresponding distribution site as a normally treated normal treatment URL and records and manages the normal treatment URL in a separate database (treatment URL DB). At this point, landing sites connected to the normal treatment URL are returned to a normal state.

The distribution site periodic inspection module 121 inspects whether or not a malicious code is additionally distributed from the normally treated distribution site at predetermined intervals. Here, the predetermined intervals may be changed by a manager at the management website.

The distribution site periodic inspection module 121 performs detection of a malicious code final distribution site, trace of a route and additional collection of files using a single browser visit.

The distribution site periodic inspection module 121 receives information on the malicious code distribution site and information on the malicious code (a hash value) distributed by the malicious code distribution site from the management server 140. In addition, the distribution site periodic inspection module 121 receives information on the time of visit inspection from the management server 140 and terminates the browser in operation when the time of visit inspection expires.

When the information on the malicious code distribution site is a JS/CSS file type, the distribution site periodic inspection module 121 also loads an HTML document for confirming the corresponding file in the browser.

The distribution site periodic inspection module 121 monitors whether or not there exists a file which is created when the URL of the malicious code distribution site is connected through a browser. If there exists a created file as a result of the inspection, the distribution site periodic inspection module 121 compares the created file with a file previously distributed from the URL of the malicious code distribution site, and if the two files are different from each other, the distribution site periodic inspection module 121 determines the created file as a newly created file, transmits the created file to the collected file self-inspection server 110 through FTP, and receives a result of the self-inspection performed on the newly created file by the collected file self-inspection server 110.

If the newly created file is normal as a result of the self-inspection, the distribution site periodic inspection module 121 records the corresponding distribution site distributing the newly created file and a landing site connected to the distribution site into a normal treatment DB.

In addition, if the created file is the same as the previously distributed file, the distribution site periodic inspection module 121 confirms details of treatment of the landing site connected to the distribution site distributing the created file by the landing site periodic inspection module 122.

If it is determined that the newly created file performs a malicious behavior as a result of the self-inspection, the distribution site periodic inspection module 121 transmits the newly created file to the management server 140 and updates the created file information. Then, the distribution site periodic inspection module 121 inspects whether or not the malicious code distribution site distributing the newly created file is recorded in an existing malicious code final distribution site list by the landing site periodic inspection module 122.

When the new file is created at an existing malicious code final distribution site, the distribution site periodic inspection module 121 detects a new malicious code final distribution site by tracing a network route.

Regardless of file creation, the distribution site periodic inspection module 121 dumps and keeps all network packets, and if a file is created and contains a new malicious code, the distribution site periodic inspection module 121 analyzes a route creating the corresponding file.

When a file is normal or is not created, the distribution site periodic inspection module 121 deletes the corresponding network packet dump.

The landing site periodic inspection module 122 inspects information on the malicious code distribution site existing at a seed URL and a sub-URL currently input in a management DB, based on a signature.

The landing site periodic inspection module 122 does not perform inspection targeting on all collected URLs, but performs the inspection targeting on URLs collected within a corresponding period according to an inspection period set through the management website. The landing site periodic inspection module 122 detects landing sites based on information on the malicious code final distribution site currently distributing the malicious code.

The landing site periodic inspection module 122 receives a list of URLs currently distributing the malicious code from the distribution site periodic inspection module 121. Then, the landing site periodic inspection module 122 receives information on a new malicious code distribution site collected through distribution site periodic inspection, which is the same as the malicious code final distribution site recorded in the DB of the management server 140.

The landing site periodic inspection module 122 confirms information on all landing sites connected to the newly detected distribution site before registering the distribution site newly detected by the distribution site periodic inspection module 121 into the DB of the management server 140 as a malicious code final distribution site.

The landing site periodic inspection module 122 receives a list of existing malicious code final distribution sites and a list of landing sites connected to the detected distribution sites from the distribution site periodic inspection module 121. Here, the list of existing malicious code final distribution sites includes a list of currently connectible malicious code final distribution sites registered in the management server 140 and a list of malicious code distribution sites collected from a blacklist providing site. In addition, the list of landing sites connected to the detected distribution sites is a list of malicious code landing sites actually connected to the URLs inspected through the distribution site inspection. The landing site periodic inspection module 122 grasps details of treatment of the landing sites, and if a signature of a malicious code distribution site does not exist in an existing landing site as a result of confirming existence of the signature, the landing site periodic inspection module 122 normally process the corresponding landing site.

The landing site periodic inspection module 122 receives a list of existing malicious code landing sites, a sub-URL list and a seed URL list from the management server 140.

The landing site periodic inspection module 122 confirms information on a normally treated and normally operating landing site from information on the landing sites registered in the management server 140. That is, the landing site periodic inspection module 122 confirms whether or not a signature of a malicious code distribution site exists in an existing landing site, and if the signature of a malicious code distribution site does not exist in the existing landing site, the landing site periodic inspection module 122 normally process the corresponding landing site.

The sub-URL list is a list of URLs collected by the management server 140 within an inspection period, and it is a target of inspection for inspecting whether or not a normal sub-URL is changed to a malicious code landing site based on the signature.

The seed URL list is a list of URLs collected by the management server 140 within an inspection period, and it is a target of inspection for inspecting whether or not a normal seed URL is changed to a malicious code landing site based on the signature.

The landing site periodic inspection module 122 inspects duplication of the received malicious code final distribution site. Then, the landing site periodic inspection module 122 utilizes information on the signature of the malicious code final distribution site, duplication of which is inspected, to inspect on landing site information.

The landing site periodic inspection module 122 inspects malicious code landing sites of inspection targets by inspecting all the landing sites having a connection relation with the detected distribution sites (inspection targets), existing malicious code landing sites, and sub-URLs and seed URLs collected within an inspection period. In addition, each of the landing site inspections should operate as a separate process.

The landing site periodic inspection module 122 confirms information on new landing sites included in the inspected landing site list, sub-URL list and seed URL list. In addition, the landing site periodic inspection module 122 confirms treated URLs among the existing landing sites and URLs untreated and connected to a malicious code distribution site.

The landing site periodic inspection module 122 records each confirmed result in the DB of the management server 140, and accumulates and manages information on the treatment or information on the new malicious code landing sites in the DB.

The landing site periodic inspection module 122 should be able to confirm a landing site activity history (time, information on the distribution site, information on the created file and the like) of a same URL.

The collected file management terminal 130 separately manages files created by visiting URLs and prepares for loss of a terminal using a dual terminal structure.

The management server 140 detects a malicious code which is not detected through the self-inspection of the collected file self-inspection server 110 performed on the collected files by inspecting the collected files using the external malicious code analysis system 200. The management server 140 manages malicious codes, normally treated URLs, and malicious code landing and distribution sites in the DB.

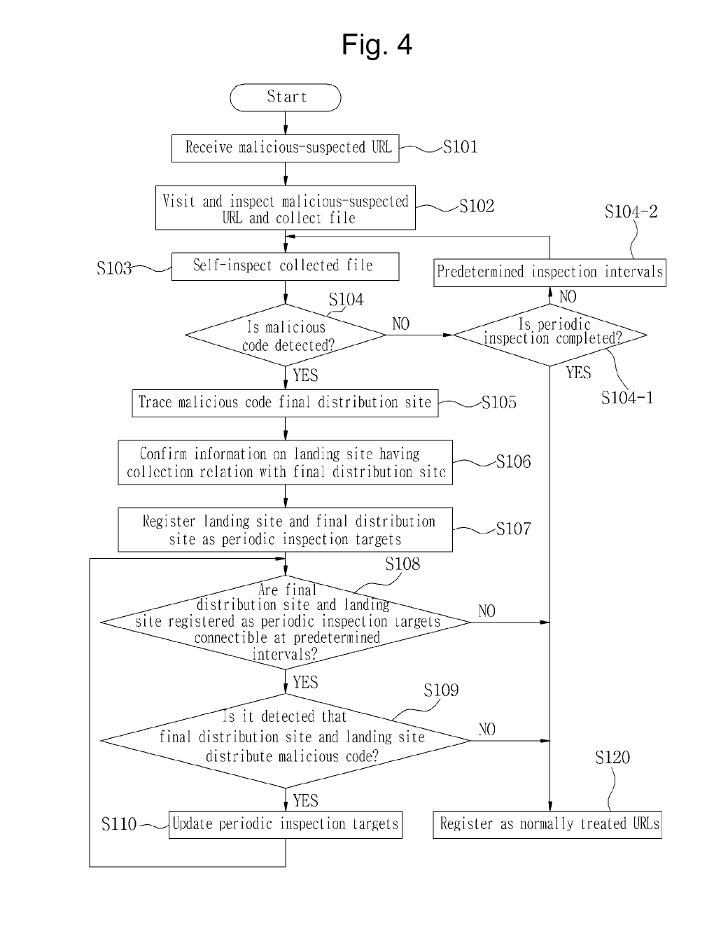

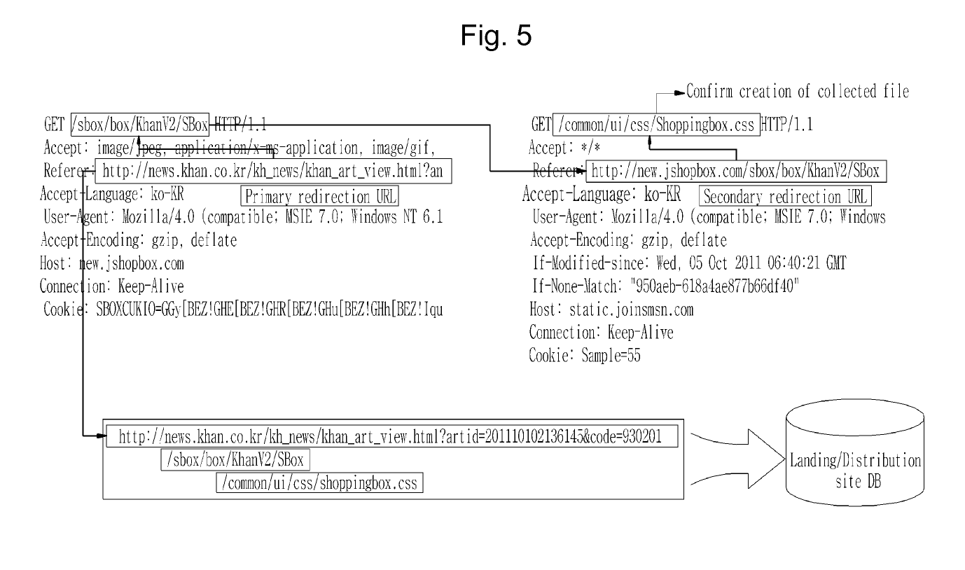

FIG. 4 is a flowchart illustrating a method of periodically inspecting malicious code distribution and landing sites according to the present invention, and FIG. 5 is an exemplary view showing a method of tracing a malicious code final distribution site related to the present invention.

Referring to FIG. 4, the landing and distribution site periodic inspection server 120 receives a malicious URL transmitted from the management server 140 S101. Here, the malicious URL is a URL registered as a malicious code distribution site, and the management server 140 also transmits information on a malicious code (a hash value) distributed by the malicious code distribution site.

The landing and distribution site periodic inspection server 120 collects a created file through a single browser visit inspection on the received URL of a malicious code distribution site S102. Here, the landing and distribution site periodic inspection server 120 collects a PF file, a document type file, an image file, a multimedia file and the like as collection targets. Then, if a file which is created when the URL of a malicious code distribution site is visited is not the same as a previously collected file, the landing and distribution site periodic inspection server 120 determines the file which is created when the URL of a malicious code distribution site is visited as a newly created file and transmits the newly created file to the collected file self-inspection server 110. At this point, the landing and distribution site periodic inspection server 120 uses hash values of the files in order to compare whether or not the file created by visit inspection is the same as the previously collected file. If the hash values of the two files are different from each other, the landing and distribution site periodic inspection server 120 determines the file created by visit inspection as a newly created file.

The collected file self-inspection server 110 receives the file collected through the visit inspection from the landing and distribution site periodic inspection server 120 and performs self-inspection on the collected file using a commercial vaccine S103. The collected file self-inspection server 110 transmits a result of the self-inspection to the landing and distribution site periodic inspection server 120.

The collected file self-inspection server 110 confirms whether or not a malicious code is detected in the collected file as a result of the self-inspection S104. Then, the collected file self-inspection server 110 performs the self-inspection again on normal files, from which a malicious code is not detected, at predetermined inspection intervals until the periodic inspection is completed S104-1 and S104-2. The collected file self-inspection server 110 creates a white list for the files determined as normal by performing the self-inspection again at predetermined inspection intervals to detect a malicious code.

If a malicious code is detected in the collected file, the landing and distribution site periodic inspection server 120 traces a malicious code final distribution site distributing the collected file from the collected file self-inspection server 110 S105. At this point, the landing and distribution site periodic inspection server 120 monitors transition of the URL creating the collected file to another web page. Then, the landing and distribution site periodic inspection server 120 confirms header information of a packet creating a file the same as the file collected while monitoring and detects a final distribution site by extracting corresponding URL information and backtracking a route by analyzing the referrer of the confirmed header information as shown in FIG. 5.

The landing and distribution site periodic inspection server 120 confirms information on a landing site connected to the malicious code final distribution site S106 and registers the detected final distribution site and the confirmed landing site as periodic inspection targets S107. That is, the landing and distribution site periodic inspection server 120 stores the detected final distribution site and the confirmed landing site in a landing/distribution site DB.

The landing and distribution site periodic inspection server 120 confirms whether or not the distribution site and the landing site registered as periodic inspection targets (alive or dead) are connectible at predetermined intervals S108.

If the distribution site and the landing site are connectible, the landing and distribution site periodic inspection server 120 directly visits the distribution site and the landing site and detects whether or not a malicious code is distributed S109.

The landing and distribution site periodic inspection server 120 updates the periodic inspection targets according to a result of detecting distribution of a malicious code S110.

If the distribution site and the landing site registered as periodic inspection targets are not connectible at step S108 or distribution of a malicious code from the distribution or landing site is not detected at step S109, URLs of the corresponding distribution and landing sites are registered as normally treated URLs S120.

The present invention may promptly confirm existence of a malicious code by inspecting a malicious behavior itself affected on a collected file using a commercial vaccine.

Further, the present invention may contribute to detecting a final distribution site undoubtedly distributing a malicious code and a landing site distributing the same file.

Furthermore, since the present invention creates and manages a white list for the files determined as normal through self-inspection, collection performance of the system can be improved by minimizing collection of normal files.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of periodically inspecting malicious code distribution and landing sites, the method comprising the steps of:
receiving a malicious-suspected URL from a management server;
collecting a file which is created when the malicious-suspected URL is connected and self-inspecting existence of the malicious code in the collected file using a commercial vaccine;
tracing, if the malicious code is detected in the collected file, a final distribution site distributing the detected malicious code;
confirming information on a landing site connected to the final distribution site and registering the final distribution site and the landing site in a landing/distribution site database;
confirming whether or not the final distribution site and the landing site registered in the landing/distribution site database are connectible; and
updating the landing/distribution site database according to whether or not the final distribution site and the landing site are connectible.

2. The method according to claim 1, wherein the self-inspection step includes the steps of:
driving, by a collected file self-inspection server, the commercial vaccine according to a vaccine driving policy received from the management server and activating a real-time update function and a real-time monitoring function of the commercial vaccine;
receiving, by the collected file self-inspection server, the collected file; and
detecting, by the collected file self-inspection server, the malicious code from the collected file using the commercial vaccine.

3. The method according to claim 2, wherein if the malicious code is detected in the collected file at the malicious code detection step, a malicious code list is created.

4. The method according to claim 2, wherein if the malicious code is not detected in the collected file at the malicious code detection step, existence of the malicious code in the collected file is re-inspected at predetermined inspection intervals, and a white list is created using normal files in which the malicious code is not detected.

5. The method according to claim 1, wherein the final distribution site tracing step confirms the final distribution site distributing the collected file in which the malicious code is detected by tracing a network route.

6. The method according to claim 1, wherein the step of confirming whether or not the distribution site and the landing site are connectible confirms whether or not the distribution site and the landing site are connectible at predetermined intervals.

7. The method according to claim 1, wherein the step of confirming whether or not the distribution site and the landing site are connectible includes the step of directly visiting the connectible distribution and landing sites and detecting whether or not the malicious code is distributed.

8. A system for periodically inspecting malicious code distribution and landing sites, the system comprising:
a landing and distribution site periodic inspection server for collecting a file by visiting and inspecting a malicious-suspected URL, tracing a final distribution site of a malicious code detected in the collected file, confirming information on a landing site connected to the final distribution site, registering the landing site in a landing/distribution site database together with the final distribution site, confirming whether or not the distribution site and the landing site registered in the landing/distribution site database are connectible at predetermined intervals, and updating the landing/distribution site database according to a result of the confirmation;
a collected file self-inspection server for self-inspecting existence of the malicious code in the collected file using a commercial vaccine and transmitting a result of the inspection to the landing and distribution site periodic inspection server; and
a management server for managing the malicious-suspected URL, the collected file, a result of inspection of the landing and distribution site periodic inspection server and the collected file self-inspection server.

9. The system according to claim 8, wherein the collected file self-inspection server sets a reception folder according to a file reception policy and receives the collected file into the corresponding reception folder.

10. The system according to claim 9, wherein the collected file self-inspection server compares a hash list of a file existing in the reception folder with a hash list created when the collected file is received and determines a file which does not exist in the hash list created when the file is received as a file including the malicious code.
